(19) United States
(12) Patent Application Publication
(10) Pub. No.: US 2024/0111559 A1
(43) Pub. Date: Apr. 4, 2024

(54) STORAGE POLICY RECOVERY MECHANISM IN A VIRTUAL COMPUTING ENVIRONMENT

(71) Applicant: VMware, Inc., Palo Alto, CA (US)

(72) Inventors: Cormac HOGAN, County Cork (IE); Duncan EPPING, Helmond (NL); Frank DENNEMAN, Purmerend (NL)

(21) Appl. No.: 17/956,619

(22) Filed: Sep. 29, 2022

(51) Int. Cl. G06F 9/455

(52) U.S. Cl. CPC G06F 9/45558; G06F 2009/4557; G06F 2009/45583; G06F 2009/45595

(57) ABSTRACT

A method for recovering a storage policy of a workload executing in a cluster of host servers that are managed by a first management appliance, wherein the host servers each include a local storage device, and the storage policy corresponds to storage objects of the workload, includes the steps of: in response to an instruction from the first management appliance, creating a first storage object of the workload according to the storage policy, wherein the instruction includes the storage policy; storing the first storage object and the storage policy in a shared storage device that is provisioned from the local storage devices of the host servers; and in response to a request from a second management appliance configured to manage the cluster of host servers, retrieving the storage policy from the shared storage device and transmitting the storage policy to the second management appliance.

### BACKGROUND

A distributed storage system allows a cluster of host servers to aggregate local storage devices thereof to create a pool of shared storage resources, also referred to as a “data store.” The data store is accessible to all the host servers and may be presented as a single namespace. Workloads such as virtual machines (VMs) executing on the host servers store objects thereof in the data store such as virtual disks and snapshots of the virtual disks. The storage objects are stored according to storage policies, e.g., based on the availability of shared storage resources, input/output (I/O) performance requirements, and data protection requirements.

For example, redundant array of independent disks (RAID) may be employed to create such storage policies. Depending on which “level” of RAID is employed for a particular storage object, storage policies may include settings for “striping,” “mirroring,” and “parity.” Through striping, the data of a storage object is split up into portions that are stored on different host servers. Through mirroring, multiple copies of an object are made and stored on different host servers. Parity information, which is calculated from the data of a storage object, may be used to reconstruct data of the storage object that is lost.

An administrator of the cluster may request for such storage policies to be created through a user interface (UI) of a virtualization manager. The virtualization manager logically groups the host servers into the cluster to perform cluster-level tasks such as provisioning and managing VMs and migrating VMs from one host server to another. Upon request, the virtualization manager creates storage policies according to which the host servers create and store storage objects in the data store. The administrator may then view and update the storage policies via the UI of the virtualization manager. However, the virtualization manager may fail such as when a host server on which the virtualization manager runs, crashes.

If the virtualization manager fails, data stored in a database of the virtualization manager, including the storage policies, is lost. Accordingly, the administrator can no longer view the storage policies via the UI of the virtualization manager unless those storage policies are recovered. The administrator could try to manually recover the storage policies by querying the host servers for information about the storage objects. However, the numbers of storage policies and storage objects created over time may be numerous, so such a manual solution is not scalable. Furthermore, such a manual solution may be complicated and error prone, which could result in data loss. For example, if the administrator accidentally creates a storage policy that does not require mirroring a storage object that was previously being mirrored, the storage object becomes at risk of being lost in the event of a local storage device failing. A scalable and dependable storage policy recovery mechanism is needed.

### SUMMARY

Accordingly, one or more embodiments provide a method for recovering a storage policy of a workload executing in a cluster of host servers that are managed by a first management appliance, wherein the host servers each include a local storage device, and the storage policy corresponds to storage objects of the workload. The method includes the steps of: in response to an instruction from the first management appliance, creating a first storage object of the workload according to the storage policy, wherein the instruction includes the storage policy, and the storage policy is stored in storage of the first management appliance; storing the first storage object and the storage policy in a shared storage device that is provisioned from the local storage devices of the host servers; and in response to a request from a second management appliance configured to manage the cluster of host servers, retrieving the storage policy from the shared storage device and transmitting the storage policy to the second management appliance.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computer system in which embodiments may be implemented.

FIG. 2A is a system diagram illustrating an example of creating a storage object according to a storage policy and storing the storage object and the storage policy in a data store.

FIG. 2B is a system diagram illustrating an example of recovering a storage policy from the data store.

FIG. 3A is a system diagram illustrating an example of creating storage objects according to a different storage policy and storing the storage objects and the different storage policy in the data store.

FIG. 3B is a system diagram illustrating another example of recovering a storage policy from the data store.

FIG. 4 is a flow diagram of steps performed by a virtualization manager and one or more storage modules of a cluster of host servers to carry out a method of creating a storage object according to a storage policy and storing the storage object and storage policy in the data store, according to an embodiment.

FIG. 5 is a flow diagram of steps performed by the virtualization manager and storage modules of the cluster of host servers to carry out a method of recovering storage policies from the data store.

### DETAILED DESCRIPTION

Techniques are described for recovering storage policies of workloads executing in a cluster of host servers. According to techniques, an administrator requests a virtualization manager to create storage policies for storage objects of the workloads. Then, the virtualization manager creates the storage policies and instructs storage modules of the host servers to create the storage objects according to the storage policies. In addition to storing the storage objects in a data store accessible to all the host servers, the storage modules also store the storage policies themselves in the data store. Later, if the virtualization manager fails, a new virtualization manager is deployed. The administrator instructs the new virtualization manager to automatically synchronize with the data store. Finally, the new virtualization manager instructs the storage modules to retrieve the storage policies from the data store and provide them to the new virtualization manager.

Because copies of the storage policies are stored in the data store along with corresponding storage objects, the storage policies are not lost when a virtualization manager fails. The storage policies may be recovered dependably and automatically regardless of the numbers of storage policies and storage objects in the data store. When a new virtualization manager is deployed, the administrator continues to manage storage policies of storage objects in the data store in a reliable manner by viewing the correct storage policies and updating the storage policies as needed, e.g., based on changes in the availability of shared storage resources, I/O performance requirements, and data protection requirements. These and further aspects of the invention are discussed below with respect to the drawings.

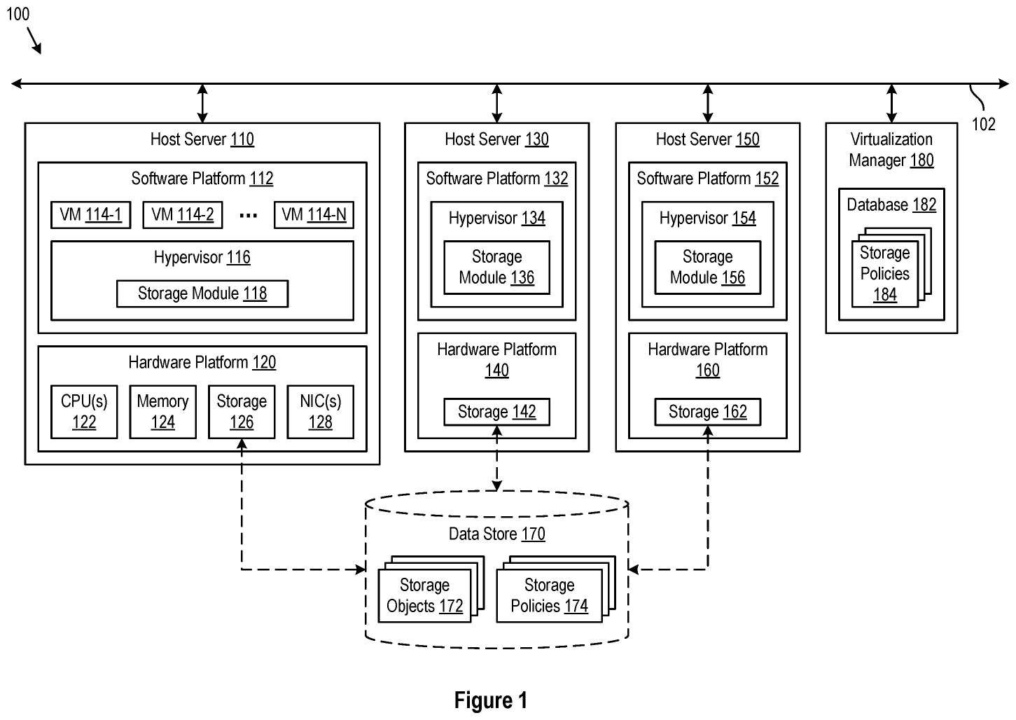

FIG. 1 is a block diagram of a virtualized computer system 100 in which embodiments may be implemented. Virtualized computer system 100 includes a cluster of host servers 110, 130, and 150, a data store 170 accessible to each of host servers 110, 130, and 150, and a virtualization manager 180.

Host server 110 is constructed on a server grade hardware platform 120 such as an x86 architecture platform. Hardware platform 120 includes conventional components of a computing device, such as one or more central processing units (CPUs) 122, memory 124 such as random-access memory (RAM), local storage 126 such as one or more magnetic drives or solid-state drives (SSDs), and one or more network interface cards (NICs) 128. CPU(s) 122 are configured to execute instructions such as executable instructions that perform one or more operations described herein, which may be stored in memory 124. Local storage 126 may be located in or attached to host server 110. NIC(s) 128 enable host server 110 to communicate with other devices over a physical network 102. Host servers 130 and 150 are also constructed on server grade hardware platforms 140 and 160, respectively, such as x86 architecture platforms. Hardware platforms 140 and 160 include conventional components of a computing device similar to those of hardware platform 120, including local storage 142 and 162, respectively.

Hardware platform 120 supports a software platform 112. Software platform 112 includes a hypervisor 116, which is a virtualization software layer. Hypervisor 116 supports a VM execution space within which workloads execute, each workload comprising one or more VMs 114 that are concurrently instantiated and executed. Hardware platforms 140 and 160 support software platforms 132 and 152, respectively. Like software platform 112, software platforms 132 and 152 include hypervisors 134 and 154, respectively. Hypervisors 134 and 154 support VM execution spaces in which workloads (not shown) execute, each workload comprising VMs that are concurrently instantiated and executed. Although the disclosure is described with reference to VMs, the teachings herein also apply to other types of workloads, including nonvirtualized applications and other types of virtual computing instances such as containers, Docker® containers, data compute nodes, and isolated user space instances for which storage policies are created and for which such storage policies are to be recovered.

Hypervisors 116, 134, and 154 include storage modules 118, 136, and 156, respectively, which may be implemented as device drivers of respective hypervisors. Storage modules 118, 136, and 156 aggregate local storage 126, 142, and 162, respectively, into a conceptual data store 170, which is commonly referred to as a virtual storage area network (VSAN) device. Data store 170 provides a single namespace for storing storage objects 172 and storage policies 174 according to which storage objects 172 are created and stored Data store 170 is accessible to host servers 110, 130, and 150, and items illustrated as being in data store 170 are actually stored in local storage 126, 142, and 162. One example of hypervisors 116, 134, and 154 is a plurality of VMware ESX® hypervisors, available from VMware, Inc. A virtualized computer system 110 is an example of a hyperconverged infrastructure because it relies on the VSAN device to provide storage for VMs running therein.

Virtualization manager 180 logically groups host servers 110, 130, and 150 into a cluster to perform cluster-level tasks such as provisioning and managing VMs and migrating VMs from one host server to another. Virtualization manager 180 communicates with host servers via a management network (not shown) provisioned from network 102. Virtualization manager 180 may be, e.g., a physical server or a VM in one of host servers 110, 130, and 150. One example of virtualization manager 180 is VMware vCenter Server®, available from VMware, Inc.

Virtualization manager 180 includes a database 182 in which storage policies 184 are stored persistently. It should be noted that if virtualization manager 180 is implemented as a VM in one of host servers 110, 130, and 150, database 182 is a portion of storage of a respective hardware platform such as a portion of storage 126 of hardware platform 120. Storage policies 184 are created by virtualization manager 180, e.g., in response to instructions from an administrator. The administrator communicates with virtualization manager 180 via a UI (not shown) of virtualization manager 180. Copies of storage policies 184 are stored as backup in data store 170 as storage policies 174 in the event of virtualization manager 180 failing and a new virtualization manager being deployed.

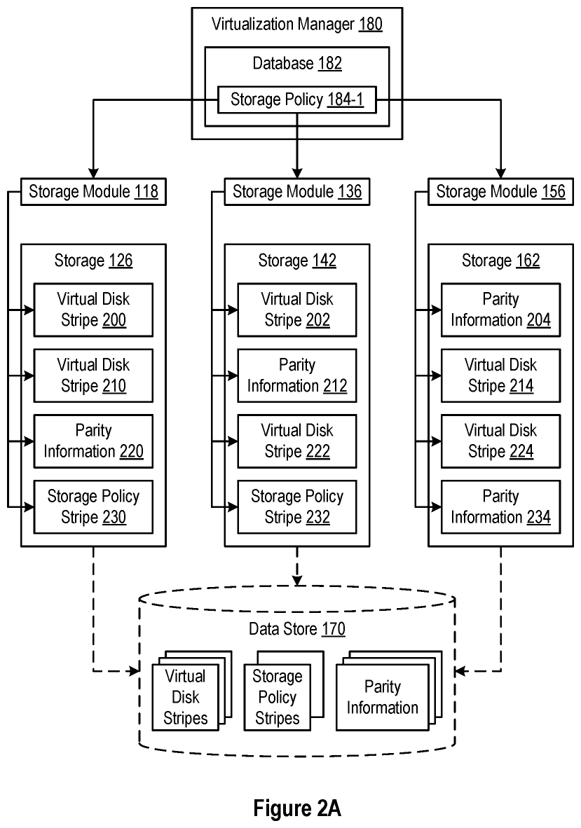

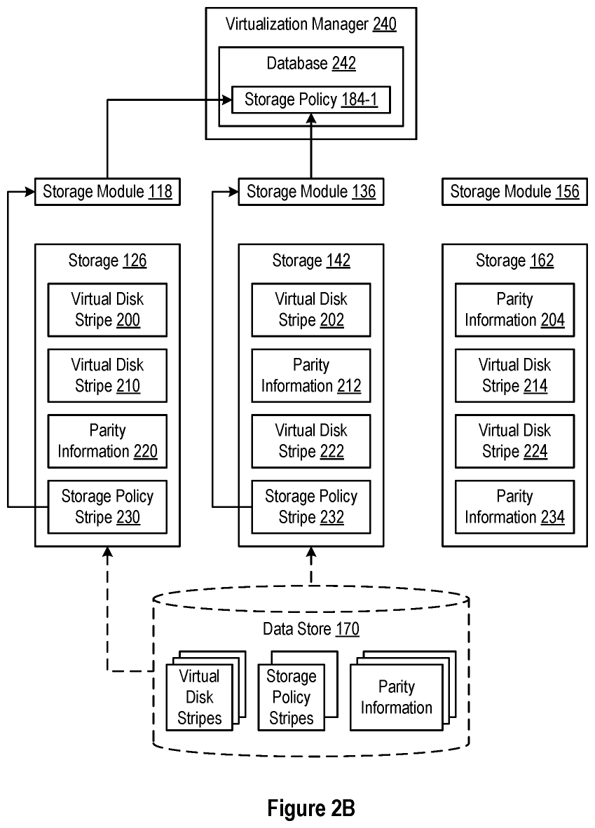

FIG. 2A is a system diagram illustrating an example of creating a storage object according to a storage policy 184-1 and storing the storage object and storage policy 184-1 in data store 170. In the example of FIG. 2A, the administrator has requested virtualization manager 180 to create storage policy 184-1 to be associated with storage objects of a workload including a virtual disk of a VM. Storage policy 184-1 specifies that its associated storage objects should be “striped” across each host server of the cluster in a “round-robin” fashion and that parity information calculated from the data of the storage objects should also be stored in each of the host servers in a round-robin fashion. Virtualization manager 180 transmits storage policy 184-1 to storage modules 118, 136, and 156 to be stored in local storage 126, 142, and 162.

For example, for a first “block” of a virtual disk, storage module 118 stores virtual disk stripe 200 in local storage 126, storage module 136 stores virtual disk stripe 202 in local storage 142, and storage module 156 stores parity information 204 in local storage 162. Virtual disk stripes 200 and 202 are portions of the first block of the virtual disk associated with storage policy 184-1, and parity information 204 is calculated from the first block. Similarly, for a second block of the virtual disk, storage module 118 stores virtual disk stripe 210 in local storage 126, storage module 136 stores parity information 212 in local storage 142, and storage module 156 stores virtual disk stripe 214 in local storage 162. Virtual disk stripes 210 and 214 are portions of the second block of the virtual disk, and parity information 212 is calculated from the second block. For a third block of the virtual disk, storage module 118 stores parity information 220 in local storage 126, storage module 136 stores virtual disk stripe 222 in local storage 142, and storage module 156 stores virtual disk stripe 224 in local storage 162. Virtual disk stripes 222 and 224 are portions of the third block of the virtual disk, and parity information 220 is calculated from the third block.

Additionally, storage module 118 stores storage policy stripe 230 in local storage 126, storage module 136 stores storage policy stripe 232 in local storage 142, and storage module 156 stores parity information 234 in local storage 162. Storage policy stripes 230 and 232 are portions of storage policy 184-1, and parity information 234 is calculated from storage policy 184-1. Conceptually, the virtual disk stripes and parity information of the first, second, and third blocks of the virtual disk associated with storage policy 184-1 and the storage policy stripes and parity information 234 of storage policy 184-1 are stored by respective storage modules in data store 170.

FIG. 2B is a system diagram illustrating an example of recovering a storage policy from data store 170. In the example of FIG. 2B, a new virtualization manager 240 has been deployed to logically group host servers 110, 130, and 150 into a cluster to perform cluster-level tasks, e.g., because virtualization manager 180 has failed. The administrator has also updated a setting of virtualization manager 240 to synchronize with data store 170. Accordingly, virtualization manager 240 requests storage modules 118, 136, and 156 to retrieve storage policies from data store 170.

To recover storage policy 184-1, storage module 118 retrieves storage policy stripe 230 from local storage 126 to transmit to virtualization manager 240, and storage module 136 retrieves storage policy stripe 232 from local storage 142 to transmit to virtualization manager 240. Virtualization manager 240 then combines storage policy stripes 230 and 232 to recover storage policy 184-1 and store in a database 242 thereof. Storage policy 184-1 includes an identifier of associated storage objects including the virtual disk and specifies storage based on striping and storing parity information in a round-robin fashion.

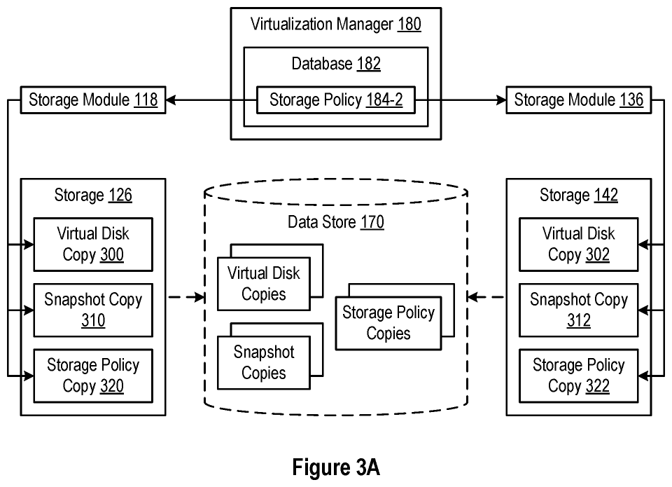

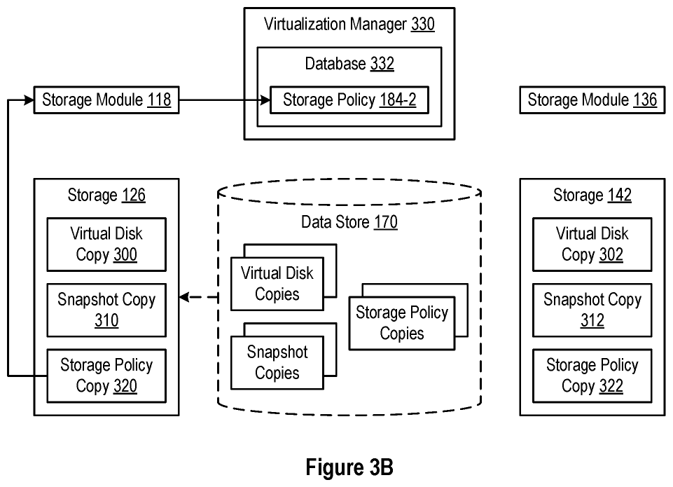

FIG. 3A is a system diagram illustrating an example of creating storage objects according to a storage policy 184-2 and storing the storage objects and storage policy 184-2 in data store 170. In the example of FIG. 3A, the administrator has requested virtualization manager 180 to create storage policy 184-2 to be associated with storage objects including a virtual disk of a VM and snapshots of the virtual disk. Storage policy 184-2 specifies that its associated storage objects should be “mirrored” across two host servers. Virtualization manager 180 has selected host servers 110 and 130 to each store a full copy of the storage objects. Accordingly, virtualization manager 180 transmits storage policy 184-2 to storage modules 118 and 136 to be stored in local storage 126 and 142.

Storage module 118 stores virtual disk copy 300, snapshot copy 310, and storage policy copy 320 in local storage 126, and storage module 136 stores virtual disk copy 302, snapshot copy 312, and storage policy copy 322 in local storage 142. Virtual disk copies 300 and 302 are each full copies of the virtual disk associated with storage policy 184-2, snapshot copies 310 and 312 are each full copies of a snapshot associated with storage policy 184-2, and storage policy copies 320 and 322 are each full copies of storage policy 184-2. Conceptually, virtual disk copies 300 and 302, snapshot copies 310 and 312, and storage policy copies 320 and 322 are stored by respective storage modules in data store 170.

FIG. 3B is a system diagram illustrating another example of recovering a storage policy from data store 170. In the example of FIG. 3B, a new virtualization manager 330 has been deployed to logically group host servers 110, 130, and 150 into a cluster to perform cluster-level tasks, e.g., because virtualization manager 180 has failed. The administrator has also updated a setting of virtualization manager 330 to synchronize with data store 170. Accordingly, virtualization manager 330 requests storage modules 118, 136, and 156 to retrieve storage policies from data store 170.

To recover storage policy 184-2, storage module 118 retrieves storage policy copy 320 from local storage 126 to transmit to virtualization manager 330. Virtualization manager 330 then stores storage policy copy 320 in a database 332 thereof as storage policy 184-2. Storage policy 184-2 includes an identifier of associated storage objects including the virtual disk and the snapshot and specifies storage based on mirroring across two host servers. It should be noted that to recover storage policy 184-2, storage module 136 may have instead retrieved storage policy copy 322 from local storage 142 to transmit to virtualization manager 330.

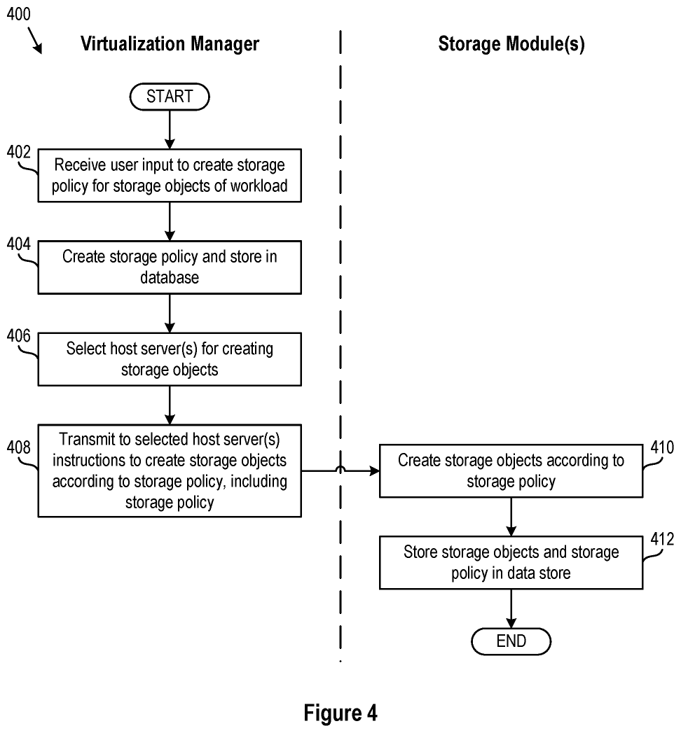

FIG. 4 is a flow diagram of steps performed by virtualization manager 180 and one or more storage modules of host servers to carry out a method 400 of creating a storage object according to a storage policy and storing the storage object and storage policy in data store 170, according to an embodiment. At step 402, virtualization manager 180 receives user input from the administrator to create a storage policy for storage objects of a workload. For example, the storage policy may include settings such as striping, mirroring, and parity, and the storage objects may be a virtual disk of a VM and snapshots of the virtual disk. At step 404, virtualization manager 180 creates the storage policy requested by the administrator, the storage policy including the requested settings and an identifier of the associated storage objects to be provisioned with that storage policy. Virtualization manager 180 stores the created storage policy in database 182. At step 406, virtualization manager 180 selects one or more host servers for creating the storage objects.

At step 408, virtualization manager 180 transmits to the host server(s) selected at step 406, instructions to create the storage objects according to the created storage policy, the instructions including the created storage policy. At step 410, storage module(s) of the host server(s) instructed at step 408 create the storage objects according to the storage policy. For example, if the storage policy includes a setting for striping, portions of the storage objects are created at multiple host servers, as illustrated in FIGS. 2A-2B. If the storage policy includes a setting for mirroring, full copies of the storage objects are created at multiple servers, as illustrated in FIGS. 3A-3B. If the storage policy includes a setting for using parity information, such parity information is calculated from data of the storage objects, as illustrated in FIGS. 2A-2B. At step 412, the storage module(s) store the storage objects and the storage policy in data store 170, i.e., to a namespace of local storage of the selected host server(s) corresponding to data store 170. After step 412, method 400 ends, and the storage module(s) may continue to create storage objects according to the storage policy such as additional snapshots and storing the storage objects in the data store.

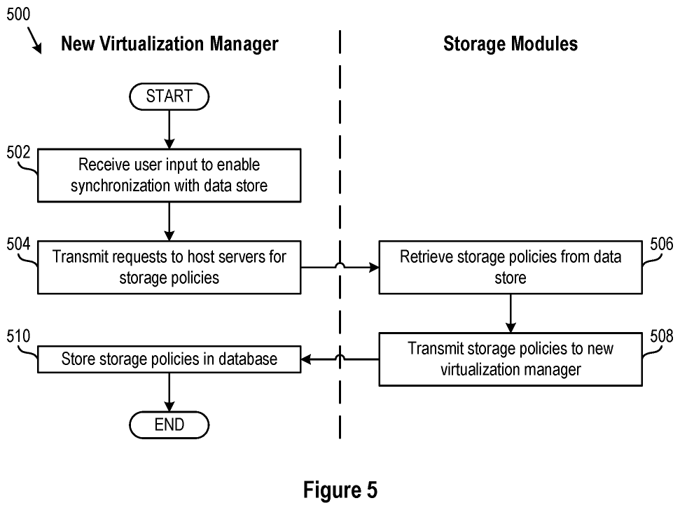

FIG. 5 is a flow diagram of steps performed by a newly deployed virtualization manager and storage modules 118, 136, and 156 to carry out a method 500 of recovering storage policies from data store 170. Method 500 is performed, e.g., after virtualization manager 180 fails and the new virtualization manager is deployed in its place. At step 502, the new virtualization manager receives user input to enable synchronization with data store 170. At step 504, the new virtualization manager transmits requests to host servers 110, 130, and 150 for storage policies stored thereby.

At step 506, storage modules 118, 136, and 156 retrieve storage policies stored thereby in data store 170, i.e., from a namespace of local storage of respective host servers corresponding to data store 170. At step 508, storage modules 118, 136, and 156 transmit the retrieved storage policies to the new virtualization manager. At step 510, the new virtualization manager stores the transmitted storage policies in a database thereof. After step 510, method 500 ends, and the administrator manages the recovered storage policies by viewing the correct storage policies and updating the storage policies as needed, e.g., based on changes in the availability of shared storage resources in data store 170, I/O performance requirements of workloads, and data protection requirements of storage objects.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method for recovering a storage policy of a workload executing in a cluster of host servers that are managed by a first management appliance, wherein the host servers each include a local storage device, and the storage policy corresponds to storage objects of the workload, the method comprising:
in response to an instruction from the first management appliance, creating a first storage object of the workload according to the storage policy, wherein the instruction includes the storage policy, and the storage policy is stored in storage of the first management appliance;
storing the first storage object and the storage policy in a shared storage device that is provisioned from the local storage devices of the host servers; and
in response to a request from a second management appliance configured to manage the cluster of host servers, retrieving the storage policy from the shared storage device and transmitting the storage policy to the second management appliance.

2. The method of claim 1, wherein the storage policy is created by the first management appliance in response to user inputs, and the second management appliance is deployed in response to a failure of the first management appliance.

3. The method of claim 1, further comprising:
creating a second storage object of the workload according to the storage policy; and
storing the second storage object in the shared storage device.

4. The method of claim 3, wherein the workload comprises a virtual machine, the first storage object is a virtual disk of the virtual machine, and the second storage object is a snapshot of the virtual disk.

5. The method of claim 1, wherein the storage policy specifies whether the first storage object is to be mirrored.

6. The method of claim 1, wherein the storage policy specifies whether different portions of the first storage object and whether parity information generated from the different portions are to be stored across the local storage devices of the host servers.

7. The method of claim 6, wherein
the host servers include first, second, and third host servers, and
a first portion of the different portions is to be stored in a local storage device of the first host server, a second portion of the different portions in a local storage device of the second host server, and a third portion of the different portions in a local storage device of the third host server.

8. A non-transitory computer-readable medium comprising instructions that are executable in a computer system, wherein the instructions when executed cause the computer system to carry out a method for recovering a storage policy of a workload executing in a cluster of host servers that are managed by a first management appliance, the host servers each include a local storage device, and the storage policy corresponds to storage objects of the workload, the method comprising:
in response to an instruction from the first management appliance, creating a first storage object of the workload according to the storage policy, wherein the instruction includes the storage policy, and the storage policy is stored in storage of the first management appliance;
storing the first storage object and the storage policy in a shared storage device that is provisioned from the local storage devices of the host servers; and
in response to a request from a second management appliance configured to manage the cluster of host servers, retrieving the storage policy from the shared storage device and transmitting the storage policy to the second management appliance.

9. The non-transitory computer-readable medium of claim 8, wherein the storage policy is created by the first management appliance in response to user inputs, and the second management appliance is deployed in response to a failure of the first management appliance.

10. The non-transitory computer-readable medium of claim 8, the method further comprising:
creating a second storage object of the workload according to the storage policy; and
storing the second storage object in the shared storage device.

11. The non-transitory computer-readable medium of claim 10, wherein the workload comprises a virtual machine, the first storage object is a virtual disk of the virtual machine, and the second storage object is a snapshot of the virtual disk.

12. The non-transitory computer-readable medium of claim 8, wherein the storage policy specifies whether the first storage object is to be mirrored.

13. The non-transitory computer-readable medium of claim 8, wherein the storage policy specifies whether different portions of the first storage object and whether parity information generated from the different portions are to be stored across the local storage devices of the host servers.

14. The non-transitory computer-readable medium of claim 13, wherein
the host servers include first, second, and third host servers, and
a first portion of the different portions is to be stored in a local storage device of the first host server, a second portion of the different portions in a local storage device of the second host server, and a third portion of the different portions in a local storage device of the third host server.

15. A computer system comprising:
first and second management appliances; and
a plurality of host servers in a cluster, wherein the host servers are managed by the first and second management appliances, and the host servers are configured to:
in response to an instruction from the first management appliance, create a first storage object of a workload according to a storage policy, wherein the instruction includes the storage policy, and the storage policy is stored in storage of the first management appliance;
store the first storage object and the storage policy in a shared storage device that is provisioned from local storage devices of the host servers; and
in response to a request from the second management appliance, retrieve the storage policy from the shared storage device and transmit the storage policy to the second management appliance.

16. The computer system of claim 15, wherein the storage policy is created by the first management appliance in response to user inputs, and the second management appliance is deployed in response to a failure of the first management appliance.

17. The computer system of claim 15, wherein host servers are further configured to:
create a second storage object of the workload according to the storage policy; and
store the second storage object in the shared storage device.

18. The computer system of claim 17, wherein the workload comprises a virtual machine, the first storage object is a virtual disk of the virtual machine, and the second storage object is a snapshot of the virtual disk.

19. The computer system of claim 15, wherein the storage policy specifies whether the first storage object is to be mirrored.

20. The computer system of claim 15, wherein the storage policy specifies whether different portions of the first storage object and whether parity information generated from the different portions are to be stored across the local storage devices of the host servers.
